(19) United States
(12) Patent Application Publication
(10) Pub. No.: US 2026/0212084 A1
(43) Pub. Date: Jul. 23, 2026

(54) TECHNIQUES FOR IMPLEMENTING GENERATIVE AI DESIGN BASED ON USER CHOICES

(71) Applicant: AUTODESK, INC., San Francisco, CA (US)

(72) Inventors: Justin Frank MATEJKA, Newmarket (CA); Jo Karel VERMEULEN, East York (CA); George William FITZMAURICE, Toronto (CA)

(21) Appl. No.: 19/340,664

(22) Filed: Sep. 25, 2025

Related U.S. Application Data
(60) Provisional application No. 63/747,834, filed on Jan. 21, 2025.

(51) Int. Cl. G06F 30/27; G06F 30/12; G06F 111/02

(52) U.S. Cl. CPC G06F 30/27; G06F 30/12; G06F 2111/02

(57) ABSTRACT

Various embodiments include a computer-implemented method for generating designs, including, receiving a first user input describing a design, generating a first set of design options based on the first user input, generating a first clarifying question related to a first attribute of the design, receiving a second user input describing the first attribute of the design, generating a second set of design options based on the first clarifying question and the second user input, generating a refined design based on the second set of design options.

### CROSS-REFERENCE TO RELATED APPLICATIONS

The present application claims priority benefit of the United States Provisional Patent Application titled, “TECHNIQUES FOR IMPLEMENTING GENERATIVE AI DESIGN BASED ON USER CHOICES,” having Serial Number 63/747,834 and filed on January 21, 2025. The subject matter of this related application is hereby incorporated herein by reference.

### BACKGROUND

### Field of the Various Embodiments

The present disclosure relates generally to computer science, artificial intelligence, and complex software and, more specifically, to techniques for implementing generative AI design based on user choices.

### Description of the Related Art

In a conventional computer-aided design (CAD) workflow, a designer uses various tools included in a CAD program to generate or assemble a design. The design could include, for example, two-dimensional (2D) images or three-dimensional (3D) geometry, among other types of data. Typically, the tools provided by the CAD program allow the designer to manually specify various attributes of the design or manipulate existing attributes of the design in an iterative and incremental manner. Some types of CAD programs now include machine learning models that implement generative artificial intelligence (AI) to automatically generate designs, or portions thereof, based on user prompts. A designer can simply describe high-level aspects of the design using natural language, and a machine learning model then automatically generates some or all of the design. Generative AI is becoming increasingly integrated into modern CAD workflows.

One drawback associated with the above approach is that conventional generative AI tools often generate designs that do not meet the expectations of designers. In particular, prompts provided by designers sometimes provide a limited amount of detail for any given design. When details are missing or underdefined in prompts, generative AI tools have to make assumptions in order to resolve those missing details. However, such assumptions are frequently inconsistent with the overall vision and expectations of the designer. When such a situation occurs, the design typically cannot be used, and the designer must restart the design process. Generative AI tools can therefore, in some cases, unnecessarily introduce inefficiencies into the design process.

As the foregoing illustrates, what is needed in the art is a more effective technique for generating designs using generative AI.

### SUMMARY

Various embodiments include a computer-implemented method for generating designs, including, receiving a first user input describing a design, generating a first set of design options based on the first user input, generating a first clarifying question related to a first attribute of the design, receiving a second user input describing the first attribute of the design, generating a second set of design options based on the first clarifying question and the second user input, generating a refined design based on the second set of design options.

At least one technical advantage of the disclosed techniques relative to the prior art is that the disclosed techniques enable the generation of designs that are more closely aligned with user expectations compared to designs generated via conventional techniques. Accordingly, the design engine can avoid generating unusable designs based on flawed assumptions. Another technical advantage of the disclosed techniques is that design options can be progressively refined and modified in response to ongoing user interactions in order to maintain consistency with an evolving design context. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of the invention;

FIG. 2 is a more detailed illustration of the design engine of FIG. 1, according to various embodiments;

FIG. 3 illustrates how the design engine of FIGS. 1-2 generates clarifying questions in response to user input, according to various embodiments;

FIG. 4 illustrates how the design engine of FIGS. 1-2 generates an intermediate design in response to user input, according to various embodiments;

FIG. 5 illustrates how the design engine of FIGS. 1-2 applies design revisions to an intermediate design in response to user input, according to various embodiments;

FIG. 6 illustrates how the design engine of FIGS. 1-2 generates design options for a portion of an intermediate design in response to user input, according to various embodiments; and

FIG. 7 is a flow diagram of methods steps for refining a design via interactions with a user, according to various embodiments.

### DETAILED DESCRIPTION OF EXEMPLARY EMBODIMENTS

In the following description, numerous specific details are set forth to provide a more thorough understanding of the various embodiments. However, it will be apparent to one skilled in the art that the inventive concepts may be practiced without one or more of these specific details.

### System Overview

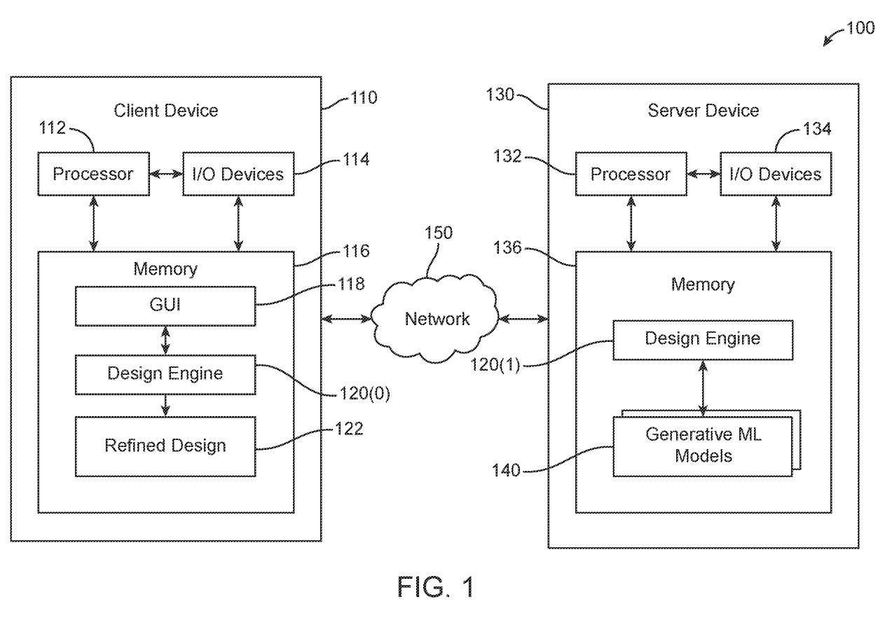

FIG. 1 illustrates a system configured to implement one or more aspects of the various embodiments. As shown, a system 100 includes a client device 110 and a server device 130 coupled together via a network 150. Client device 110 or server device 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others.

As further shown, client device 110 includes a processor 112, input/output (I/O) devices 114, and a memory 116, coupled together. Processor 112 includes any technically feasible set of hardware units configured to process data and execute software applications. For example, and without limitation, processor 112 could include one or more central processing units (CPUs) and/or one or more graphics processing units (GPUs). I/O devices 114 include any technically feasible set of devices configured to perform input and/or output operations, including, for example and without limitation, a display device, a keyboard, and/or a touchscreen, among others.

Memory 116 includes any technically feasible storage media configured to store data and software applications, such as, for example and without limitation, a hard disk, a random-access memory (RAM) module, and/or a read-only memory (ROM). Memory 116 includes a graphical user interface (GUI) 118, a design engine 120(0), and a refined design 122. Design engine 120(0) is a software application that, when executed by processor 112, interoperates with a corresponding design engine executing on server device 130 to generate refined design 122 based on interactions performed with a user via GUI 118. GUI 118 includes user interface elements that, when displayed to a user via a display device, allow a user to provide various types of input and receive various types of output.

Server 130 includes a processor 132, I/O devices 134, and a memory 136, coupled together. Processor 132 includes any technically feasible set of hardware units configured to process data and execute software applications, such as one or more CPUs and/or one or more GPUs. I/O devices 134 include any technically feasible set of devices configured to perform input and/or output operations, such as, for example and without limitation, a display device, a keyboard, and/or a touchscreen, among others.

Memory 136 includes any technically feasible storage media configured to store data and software applications, such as, for example and without limitation, a hard disk, a RAM module, and/or a ROM. Memory 136 includes a design engine 120(1) and one or more generative machine learning (ML) models 140. Generative ML models 140 are trained using vast amounts of data to process multi-modal prompts using techniques associated with generative AI. Generative ML models 140 can include large language models (LLMs), visual language models (VLMs), other transformer-based models, deep neural networks (DNNs), convolutional neural networks (CNNs), or any other technically feasible set of algorithms configured to generate designs based on natural language and/or other inputs. The designs could include, for example and without limitation, two-dimensional (2D) images and/or three-dimensional (3D) geometry. In one embodiment, generative ML models 140 may be configured to interact with one or more application programming interface (API) endpoints in order to transmit prompts and receive responses from other ML models located on one or more remote servers.

Design engine 120(1) is a software application that, when executed by processor 132, interoperates with design engine 120(0) executing on client 110 to coordinate any of the different operations described herein. Design engines 120(0) and 120(1) represent distinct portions of a distributed software entity that is configured to perform any and all of the various operations described herein. Thus, for simplicity, design engines 120(0) and 120(1) are collectively referred to hereinafter as design engine 120.

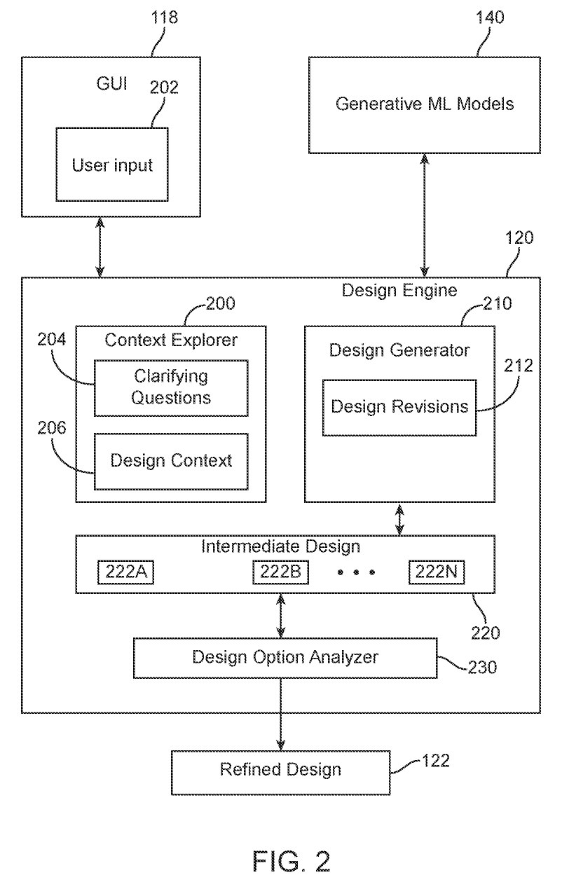

Design engine 120 is configured to interact with GUI 118 in order to expose a CAD environment to a user via which the user can provide input for generating 2D and/or 3D designs. In operation, design engine 120 receives prompts from the user that describe various attributes of a design. Design engine 120 analyzes the prompts and then generates clarifying questions that explore attributes of the design that are undefined and/or underdefined. The design engine 120 then outputs these clarifying questions to the user in order to generate and/or update a design context. The design context includes data that defines the design. The design engine 120 can then generate an intermediate design that includes one or more design options. Based on further interactions with the user, the design engine 120 can generate design revisions that, when applied to the intermediate design, further align the intermediate design with the design context and, under nominal circumstances, the expectations of the user. The various operations performed by design engine 120 are described in greater detail below in conjunction with FIG. 2.

### Implementing Generative AI Design Based on User Choices

FIG. 2 is a more detailed illustration of the design engine of FIG. 1, according to various embodiments. As shown, design engine 120 includes a context explorer 200, a design generator 210, an intermediate design 220, and a design option analyzer 230. In operation, design engine 120 is configured to interact with a user via GUI 118 in order to interactively obtain user input 202. Design engine 120 is also configured to implement one or more generative ML models 140 in order to iteratively generate and refine intermediate design 220 until various criteria are met, thereby generating refined design 122.

In particular, context explorer 200 initially receives user input 202 that broadly captures higher-level design attributes and/or lower-level design attributes of a design. User input 202 can include any technically feasible type of data. In one embodiment, user input 202 can be a multi-modal prompt. In practice, however, user input 202 generally includes at least a text description of the design at a given level of detail. Context explorer 200 analyzes user input 202 and identifies one or more underdefined attributes of the design. Context explorer 200 then generates clarifying questions 204 that seek to explore these underdefined attributes. Context explorer 200 outputs clarifying questions 204 to the user via GUI 118. Context explorer 200 then receives additional user input 202 via GUI 118 that includes additional details provided by the user in response to clarifying questions 204. Context explorer 200 can repeat this process in order to iteratively interact with the user, in a turn-based manner, to explore various attributes and details of the design.

While interacting with the user in this manner, context explorer 200 generates and/or updates design context 206 to include any and/or all descriptive information related to the design received via user input 202. In one embodiment, design context 206 includes a conversation history that includes the various interactions between context explorer 200 and the user across any number of conversational iterations. Context explorer 200 thus accumulates relevant details in design context 206 by interviewing the user and clarifying specific, underdefined attributes of the design. In conjunction with this process, context explorer 200 also evaluates design context 206 on an ongoing basis in order to determine whether sufficient detail is available to generate a version of the design. Context explorer 200 can implement any technically feasible criteria in order to determine that sufficient detail is available. In one embodiment, context explorer 200 may determine that a version of the design can be generated after a threshold number of clarifying questions 204 has been provided to the user.

When design context 206 includes a sufficient level of detail, design generator 210 implements generative ML models 140 to generate intermediate design 220. Intermediate design 220 includes one or more design options 222A, 222B, through 222N. A given design option 222 represents a version of the design generated based on the current state of design context 206. Design generator 210 can display intermediate design 220 to the user via GUI 118, and context explorer 200 can then prompt the user for feedback and/or provide additional clarifying questions 204 relevant to intermediate design 220. In some instances, the user may provide user input 202 that further clarifies design context 206, and, in response, design generator 210 then generates design revisions 212. A given design revision 212 generally includes a modification to intermediate design 220 and/or one or more of design options 222, potentially including the elimination of design options 222 that conflict with design context 206. The above process can occur repeatedly, in an iterative manner, thereby allowing the user to refine intermediate design 220.

During the above process, design option analyzer 230 evaluates design options 222 and assesses whether any convergence criteria are met, indicating that some or all design options 222 are sufficiently similar to one another. In so doing, design options analyzer 230 can implement any technically feasible approach for comparing 2D or 3D geometry to determine a degree of similarity. In one embodiment, design option analyzer 230 generates an embedding for each design option 222 and projects those embeddings into a multi-dimensional vector space. Design option analyzer 230 can then evaluate the proximity of those embeddings in the multi-dimensional space to determine that the convergence criteria is met. For example, and without limitation, design option analyzer 230 could determine that each embedding resides within a given region of the multi-dimensional vector space having a given volume. This technique can also be applied to eliminate divergent designs having embeddings that reside well outside of a central cluster where other embeddings reside.

When design option analyzer 230 determines that the convergence criteria is met, design option analyzer 230 generates refined design 122. In so doing, design option analyzer 230 can evaluate each design option 222 and identify one such option that is most closely aligned with design context 206. Design option analyzer 230 can also combine two or more design options 222 to generate refined design 122. In performing these techniques, design option analyzer 230 can implement generative ML models 140 to generate and/or update design geometry associated with design options 222.

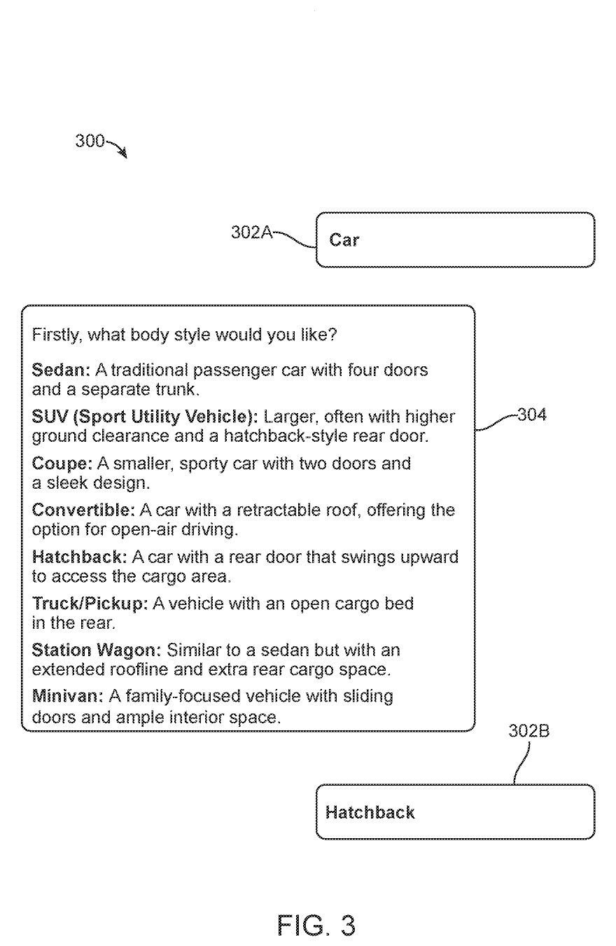

Via the techniques described thus far, design engine 120 is capable of iteratively refining a design in a step-by-step manner based on interactions with the user. By prompting the user with questions that target underdefined attributes of the design, design engine 120 can avoid making assumptions that lead to poor designs. Accordingly, the disclosed techniques provide a significant improvement over conventional approaches that often lead to unusable designs. Various examples of how design engine 120 interacts with the user to refine a design are set forth below in conjunction with FIGS. 3-6.

FIG. 3 illustrates how the design engine of FIGS. 1-2 generates clarifying questions in response to user input, according to various embodiments. As shown, in an exemplary conversation 300, a user initially provides user input 302A that describes a design. In this instance, the design is a car. In response, context explorer 200 within design engine 120 generates clarifying questions 304 that serve to explore a deeper level of detail associated with the design. Here, clarifying questions 304 explore what body style the car should have and further provide examples along with corresponding description in order to assist the user in providing design details. In response, the user provides additional input 302B indicating that the desired body style is a hatchback. Context explorer 200 captures exemplary conversation 300 in design context 206 for subsequent use by design generator 210 in generating intermediate designs 220.

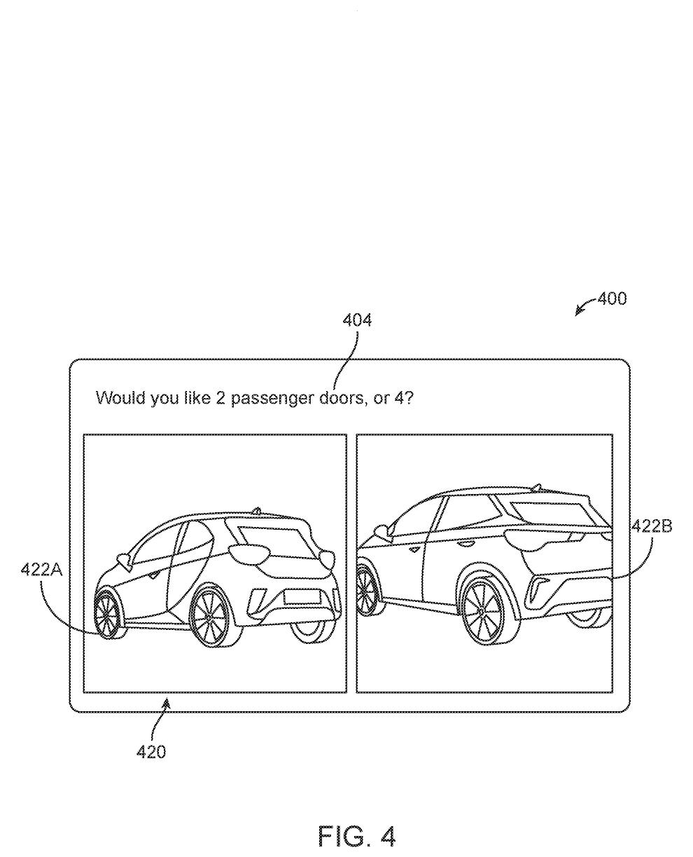

FIG. 4 illustrates how the design engine of FIGS. 1-2 generates an intermediate design in response to user input, according to various embodiments. As shown, exemplary output 400 includes an intermediate design 420 that, in turn, includes design options 422A and 422B. Design generator 210 within design engine 120 can generate intermediate design 420 based on exemplary conversation 300 discussed above in conjunction with FIG. 3. In particular, once context explorer 200 clarifies the desired body style via clarifying questions 304 and updates design context 206 accordingly, design generator 210 can then implement generative ML models 140 to generate intermediate design 420 based on design context 206.

In conjunction with this process, context explorer 200 can generate one or more additional clarifying questions 404 that serve to define specific attributes of the various design options 422. In the example shown, design options 422 include a range of number of passenger doors, making this particular attribute underdefined. Context explorer 200 can evaluate design options 422 and determine that the number of passenger doors is an underdefined attribute that should be clarified and then generate clarifying questions 404 in response. In this manner, context explorer 200 and design generator 210 coordinate operations to provide the user with progressively more well-defined versions of a design.

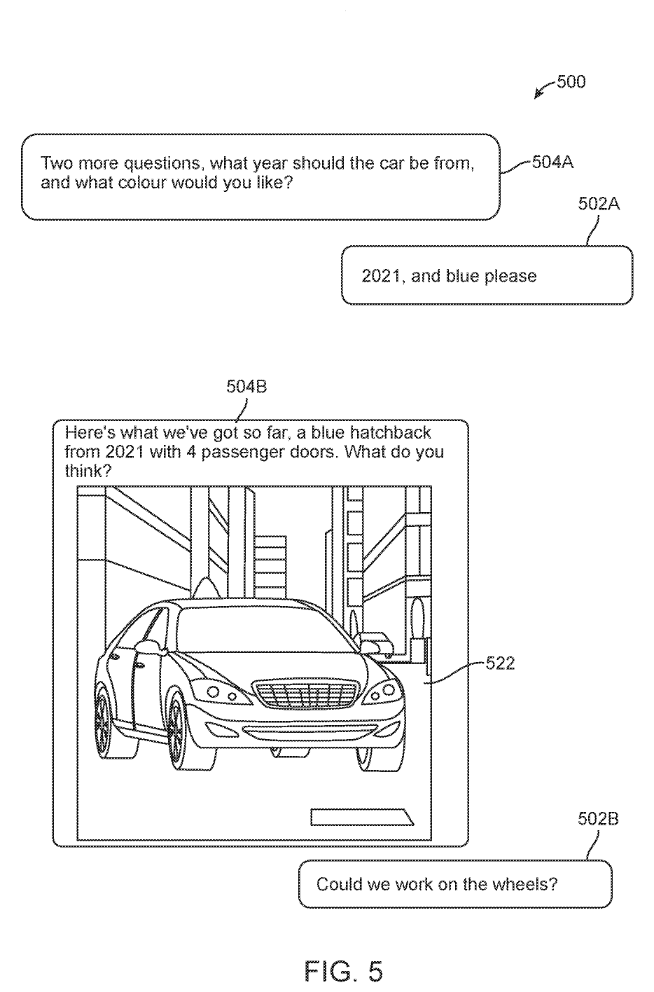

FIG. 5 illustrates how the design engine of FIGS. 1-2 applies design revisions to an intermediate design in response to user input, according to various embodiments. As shown, in exemplary conversation 500, context explorer 200 outputs clarifying questions 504A inquiring about the desired year and color of the car being designed, and in response, the user provides user input 502A. Context explorer 200 integrates the additional information provided by such interaction into design context 206. Design generator 210 can then process design context 206 and generate, using generative ML models 140, design revisions 212.

Design revisions 212 indicate changes to intermediate design 220 that bring design options 222 into better alignment with the design described in design context 206. In particular, in the example discussed herein, a given design revision 212 could include stylistic changes associated with the year indicated by the user or changes to the surface of the car to achieve the desired color. Generally, a given design revision 212 can include any stylistic, thematic, and/or functional modification to any given design option or portion of a design. A given design revision 212 could also eliminate specific design options 222 altogether, if, for example and without limitation, those design options are inconsistent and/or contradictory to design context 206.

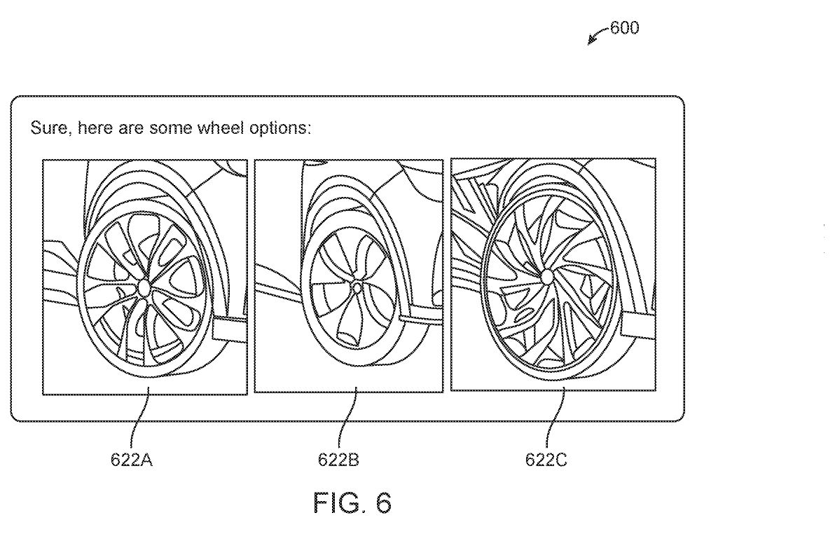

Design generator 210 generates design option 522 and outputs clarifying question 504B to the user to verify that the design revisions applied in response to user input 502A are satisfactory. Design generator 210 can then generate additional design options 222 that include finer details of the design in response to feedback from the user regarding a specific portion of the design. In this example, the user provides user input 502B, indicating that the user wishes to focus on the wheels of the car. Design generator 210 can then generate additional design options in the manner described below in conjunction with FIG. 6.

FIG. 6 illustrates how the design engine of FIGS. 1-2 generates design options for a portion of an intermediate design in response to user input, according to various embodiments. As shown, design generator 210 generates design options 622A, 622B, and 622C in response to user input 502B shown in FIG. 5. As discussed above, design generator 210 can generate design options corresponding to a portion of the design. Here, design generator 210 generates design options 622 for the wheels of the car. Such an approach facilitates iterative refinement of the design, where the user can provide additional detail regarding the design as a whole and also specific portions of the design.

The functionality of design engine 120 is described by way of example in conjunction with FIGS. 3-6 in order to illustrate how designs can be refined via various types of interactions with the user. The examples described in conjunction with these figures are not meant to be limiting, and those skilled in the art will understand that the disclosed techniques can be broadly applied to support any type of design process associated with any technically feasible type of design.

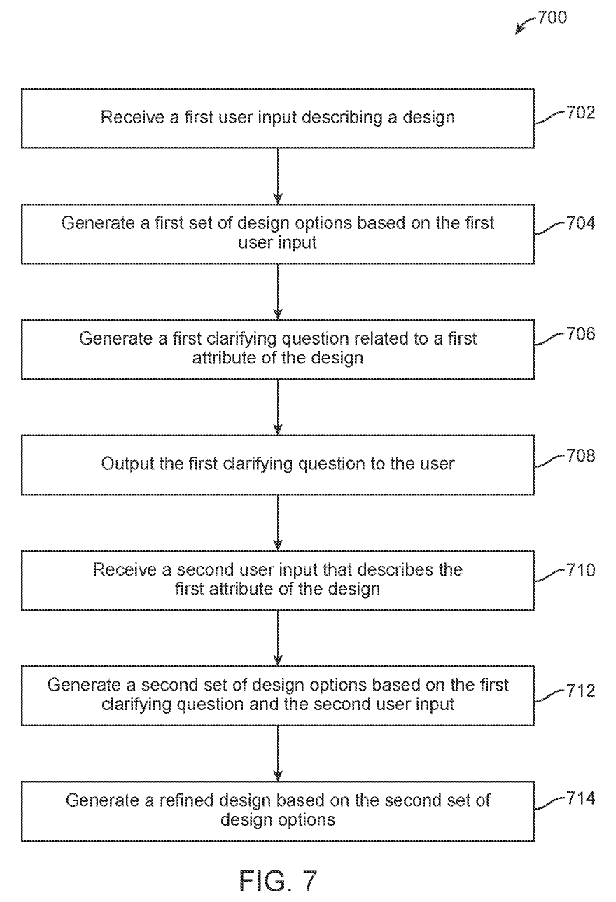

FIG. 7 is a flow diagram of method steps for refining a design via interactions with a user, according to various embodiments. Although the method steps are described in conjunction with the systems of FIGS. 1-6, persons skilled in the art will understand that any system configured to perform the method steps, in any order, is within the scope of the present embodiments.

As shown, a method 700 begins at step 702 where context explorer 200 within design engine 120 receives a first user input describing a design. The first user input can be any technically feasible type of prompt and include any technically feasible media, including text, 2D images, 3D geometry, or any combination thereof. The first user input can include any given level of detail. In response to receiving the first user input, context explorer 200 generates or updates design context 206. Design context 206 is a data structure used to track any and all data associated with the design.

At step 704, design generator 210 generates a first set of design options based on the first user input. The first set of design options can be included in intermediate design 220. Design generator 210 implements generative ML models 140 to generate 2D or 3D geometry based on design context 206. Generative ML models 140 can include large language models (LLMs), visual language models (VLMs), other transformer-based models, deep neural networks (DNNs), convolutional neural networks (CNNs), or any other technically feasible set of algorithms configured to generate design elements for designs based on natural language and/or other inputs. The design elements could include, for example and without limitation, two-dimensional (2D) images and/or three-dimensional (3D) geometry. Design generator 210 can display the first set of design options to the user via GUI 118.

At step 706, context explorer 200 generates a first clarifying question related to a first attribute of the design. Context explorer 200 is configured to analyze design context 106 and identify any underdefined aspects of the design. Context explorer 200 can then generate the first clarifying question to explore these underdefined aspects of the design. Context explorer 200 can implement generative ML models 140 to generate the first clarifying question. In one embodiment, context explorer 200 can compare an existing description of a similar design to the description of the design set forth in design context 206, and then identify attributes of the design that are less defined compared to corresponding attributes of the similar design. At step 708, context explorer 200 outputs the first clarifying question to the user via GUI 118.

At step 710, context explorer 200 receives a second user input from the user that describes the first attribute of the design. The second user input is a response to the first clarifying question and provides additional detail previously determined to be underdefined. Context explorer 200 incorporates the second user input into design context 206.

At step 712, design generator 210 generates a second set of design options based on the first clarifying question and the second user input. In doing so, design generator 210 can generate design revisions 212 that can be applied to the first set of design options. Design revisions 212 can include specific changes to individual design options included in the first set of design options or can include indications of specific design options that should be eliminated from the first set of design options, among other possibilities.

At step 714, design option analyzer 230 analyzes the second set of design options and generates refined design 122. Design option analyzer 230 evaluates the second set of design options 222 and assesses whether one or more convergence criteria are met, indicating that some or all of those design options are sufficiently similar to one another. In so doing, design option analyzer 230 can implement any technically feasible approach for comparing 2D or 3D geometry to determine a degree of similarity. In one embodiment, design option analyzer 230 generates an embedding for each design option 222 and projects those embeddings into a multi-dimensional vector space. Design option analyzer 230 can then evaluate the proximity of those embeddings in the multi-dimensional space to determine that the convergence criteria is met. This technique can also be applied to eliminate divergent designs having embeddings that reside beyond a threshold distance from a central cluster where other embeddings reside.

In sum, a design engine is configured to interact with a user in order to iteratively generate and refine a design. The design engine includes a context explorer that processes user inputs describing the design and then generates clarifying questions intended to resolve undefined or underdefined aspects of the design. The design engine generates and updates a design context based on interactions with the user in order to capture details of the design. The design engine includes a design generator that processes the design context and generates an intermediate design that reflects the various details of the design captured in the design context. The intermediate design includes various design options that represent different versions of the design. The context explorer can present the design options to the user and gather additional user input for the design context. The design generator can then generate and apply design revisions to the design options in order to align the intermediate design with the design context. The design engine includes a design option analyzer that evaluates the design options and determines when convergence criteria are met. When the convergence criteria are met, the design option analyzer outputs a refined design.

At least one technical advantage of the disclosed techniques relative to the prior art is that the disclosed techniques enable the generation of designs that are more closely aligned with user expectations compared to designs generated via conventional techniques. Accordingly, the design engine can avoid generating unusable designs based on flawed assumptions. Another technical advantage of the disclosed techniques is that design options can be progressively refined and modified in response to ongoing user interactions in order to maintain consistency with an evolving design context. These technical advantages provide one or more technological advancements over prior art approaches.

1. Various embodiments include a computer-implemented method for generating designs, the method comprising receiving a first user input describing a design, generating a first set of design options based on the first user input, generating a first clarifying question related to a first attribute of the design, receiving a second user input describing the first attribute of the design, generating a second set of design options based on the first clarifying question and the second user input, and generating a refined design based on the second set of design options.

2. The computer-implemented method of clause 1, further comprising generating a design context based on the first user input, and updating the design context based on the second user input, wherein the second set of design options is further generated based on the design context.

3. The computer-implemented method of any of clauses 1-2, further comprising generating a first design revision based on the first user input, wherein the second set of design options is generated by applying the first design revision to the first set of design options.

4. The computer-implemented method of any of clauses 1-3, wherein the second set of design options resides in an intermediate design, and further comprising analyzing the intermediate design to determine that a convergence criterion is met, wherein the refined design is generated in response to the convergence criterion being met.

5. The computer-implemented method of any of clauses 1-4, further comprising generating a set of embeddings based on the second set of design options, and determining that the set of embeddings occupies a first region of a multi-dimensional space.

6. The computer-implemented method of any of clauses 1-5, further comprising generating a set of embeddings based on the second set of design options, determining that a first embedding resides greater than a threshold distance from one or more other embeddings included in the set of embeddings when projected into a multi-dimensional space, and eliminating a first design option that corresponds to the first embedding from the second set of design options.

7. The computer-implemented method of any of clauses 1-6, further comprising determining that the first attribute of the design is underdefined.

8. The computer-implemented method of any of clauses 1-7, wherein generating the first set of design options comprises implementing a generative machine learning model to generate design geometry.

9. The computer-implemented method of any of clauses 1-8, wherein the first clarifying question pertains to a first portion of the design, and wherein the second set of design options includes modifications to the first portion of the design.

10. The computer-implemented method of any of clauses 1-9, wherein the first user input pertains to a first portion of the design, and wherein the second set of design options includes different versions of the first portion of the design.

11. Various embodiments include one or more non-transitory computer readable media storing instructions that, when executed by one or more processors, cause the one or more processors to generate designs by performing the steps of receiving a first user input describing a design, generating a first set of design options based on the first user input, generating a first clarifying question related to a first attribute of the design, receiving a second user input describing the first attribute of the design, generating a second set of design options based on the first clarifying question and the second user input, and generating a refined design based on the second set of design options.

12. The one or more non-transitory computer readable media of clause 11, further comprising the steps of generating a design context based on the first user input, and updating the design context based on the second user input, wherein the second set of design options is further generated based on the design context.

13. The one or more non-transitory computer readable media of any of clauses 11-12, further comprising the steps of generating a first design revision based on the first user input, wherein the second set of design options is generated by applying the first design revision to the first set of design options.

14. The one or more non-transitory computer readable media of any of clauses 11-13, wherein the second set of design options resides in an intermediate design, and further comprising analyzing the intermediate design to determine that a convergence criterion is met, wherein the refined design is generated in response to the convergence criterion being met.

15. The one or more non-transitory computer readable media of any of clauses 11-14, further comprising the steps of generating a set of embeddings based on the second set of design options, and determining that the set of embeddings occupies a first region of a multi-dimensional space.

16. The one or more non-transitory computer readable media of any of clauses 11-15, further comprising the steps of generating a set of embeddings based on the second set of design options, determining that a first embedding resides greater than a threshold distance from one or more other embeddings included in the set of embeddings when projected into a multi-dimensional space, and eliminating a first design option that corresponds to the first embedding from the second set of design options.

17. The one or more non-transitory computer readable media of any of clauses 11-16, further comprising the steps of determining that the first attribute of the design is underdefined.

18. The one or more non-transitory computer readable media of any of clauses 11-17, further comprising the steps of generating a summary of options for at least one underdefined attribute of the design.

19. The one or more non-transitory computer readable media of any of clauses 11-18, further comprising the steps of generating a summary of changes made when generating the second set of design options.

20. A computer system, comprising one or more memories that include instructions, and one or more processors that are coupled to the one or more memories and, when executing the instructions, are configured to generate designs by receiving a first user input describing a design, generating a first set of design options based on the first user input, generating a first clarifying question related to a first attribute of the design, receiving a second user input describing the first attribute of the design, generating a second set of design options based on the first clarifying question and the second user input, and generating a refined design based on the second set of design options.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating designs, the method comprising:
receiving a first user input describing a design;
generating a first set of design options based on the first user input;
generating a first clarifying question related to a first attribute of the design;
receiving a second user input describing the first attribute of the design;
generating a second set of design options based on the first clarifying question and the second user input; and
generating a refined design based on the second set of design options.

2. The computer-implemented method of claim 1, further comprising:
generating a design context based on the first user input; and
updating the design context based on the second user input, wherein the second set of design options is further generated based on the design context.

3. The computer-implemented method of claim 1, further comprising generating a first design revision based on the first user input, wherein the second set of design options is generated by applying the first design revision to the first set of design options.

4. The computer-implemented method of claim 1, wherein the second set of design options resides in an intermediate design, and further comprising analyzing the intermediate design to determine that a convergence criterion is met, wherein the refined design is generated in response to the convergence criterion being met.

5. The computer-implemented method of claim 1, further comprising:
generating a set of embeddings based on the second set of design options; and
determining that the set of embeddings occupies a first region of a multi-dimensional space.

6. The computer-implemented method of claim 1, further comprising:
generating a set of embeddings based on the second set of design options;
determining that a first embedding resides greater than a threshold distance from one or more other embeddings included in the set of embeddings when projected into a multi-dimensional space; and
eliminating a first design option that corresponds to the first embedding from the second set of design options.

7. The computer-implemented method of claim 1, further comprising determining that the first attribute of the design is underdefined.

8. The computer-implemented method of claim 1, wherein generating the first set of design options comprises implementing a generative machine learning model to generate design geometry.

9. The computer-implemented method of claim 1, wherein the first clarifying question pertains to a first portion of the design, and wherein the second set of design options includes modifications to the first portion of the design.

10. The computer-implemented method of claim 1, wherein the first user input pertains to a first portion of the design, and wherein the second set of design options includes different versions of the first portion of the design.

11. One or more non-transitory computer readable media storing instructions that, when executed by one or more processors, cause the one or more processors to generate designs by performing the steps of:
receiving a first user input describing a design;
generating a first set of design options based on the first user input;
generating a first clarifying question related to a first attribute of the design;
receiving a second user input describing the first attribute of the design;
generating a second set of design options based on the first clarifying question and the second user input; and
generating a refined design based on the second set of design options.

12. The one or more non-transitory computer readable media of claim 11, further comprising the steps of:
generating a design context based on the first user input; and
updating the design context based on the second user input, wherein the second set of design options is further generated based on the design context.

13. The one or more non-transitory computer readable media of claim 11, further comprising the steps of generating a first design revision based on the first user input, wherein the second set of design options is generated by applying the first design revision to the first set of design options.

14. The one or more non-transitory computer readable media of claim 11, wherein the second set of design options resides in an intermediate design, and further comprising analyzing the intermediate design to determine that a convergence criterion is met, wherein the refined design is generated in response to the convergence criterion being met.

15. The one or more non-transitory computer readable media of claim 11, further comprising the steps of:
generating a set of embeddings based on the second set of design options; and
determining that the set of embeddings occupies a first region of a multi-dimensional space.

16. The one or more non-transitory computer readable media of claim 11, further comprising the steps of:
generating a set of embeddings based on the second set of design options;
determining that a first embedding resides greater than a threshold distance from one or more other embeddings included in the set of embeddings when projected into a multi-dimensional space; and
eliminating a first design option that corresponds to the first embedding from the second set of design options.

17. The one or more non-transitory computer readable media of claim 11, further comprising the steps of determining that the first attribute of the design is underdefined.

18. The one or more non-transitory computer readable media of claim 11, further comprising the steps of generating a summary of options for at least one underdefined attribute of the design.

19. The one or more non-transitory computer readable media of claim 11, further comprising the steps of generating a summary of changes made when generating the second set of design options.

20. A computer system, comprising:
one or more memories that include instructions; and
one or more processors that are coupled to the one or more memories and, when executing the instructions, are configured to generate designs by:
receiving a first user input describing a design,
generating a first set of design options based on the first user input,
generating a first clarifying question related to a first attribute of the design,
receiving a second user input describing the first attribute of the design,
generating a second set of design options based on the first clarifying question and the second user input, and
generating a refined design based on the second set of design options.
